(19) United States
(12) Patent Application Publication
(10) Pub. No.: US 2006/0114690 A1
(43) Pub. Date: Jun. 1, 2006

(54) Back-lighting unit and liquid crystal display using the same

(76) Inventors: Seiji Iki, Kanagawa (JP); Toshiyuki Morita, Kanagawa (JP)

Correspondence Address: WHITHAM, CURTIS & CHRISTOFFERSON, P.C., SUITE 340, 11491 SUNSET HILLS ROAD, RESTON, VA, 20190, US

(21) Appl. No.: 11/270,641

(22) Filed: Nov. 10, 2005

(30) Foreign Application Priority Data
Nov. 26, 2004 (JP) 342638/2004

(51) Int. Cl. F21V 7/04

(52) U.S. Cl. 362/612; 362/615; 362/600

(57) ABSTRACT

Light color beams respectively from LEDs formed on an LED array substrate are allowed to enter one edge of second light guide plates for color mixing, which is arranged to either side of the LEDs. In each of the second light guide plates, color mixing of the respective color light beams occurs with increasing distance from this one edge, and thereby white light is obtained. This white light is guided out through the other edge of the second guide light plate, is reflected by a second reflection plate, and then is allowed to enter either of two opposite edges of a first light guide plate. The white light having entered the first light guide plate is radiated out from a front surface thereof.

### BACKGROUND OF THE INVENTION

1. Field of the Invention

The present invention relates to a back-lighting unit, and to a liquid crystal display using the same. In particular, the invention relates to a back-lighting unit using light emitting diodes in plural colors as a light source, and to a liquid crystal display using the same.

2. Description of the Related Art

For a liquid crystal display, since it is a display device which does not emit light by itself, a front-lighting unit or a back-lighting unit is often used for the purpose of enhancing visibility and brightness of the device. As a light source for a back-lighting unit constituting a back-lighting unit, fluorescent lamps have been mainly used until recently, but it has been proposed to use light emitting diodes (LEDs) having advantages which are a long lifetime and an excellent luminous efficiency.

The back-lighting unit using light emitting diodes as a light source is proposed in “High-efficiency slim LED backlight system with mixing light guide” (SID 03 DIGEST, 43.3 by Martynov, pp. 1259-1261). An outline thereof will be briefly described. As shown in FIGS. 9A and 9B, a back-lighting unit 100 includes: a light guide plate 106; an LED array substrate 102 arranged at a back surface of the light guide plate 106 and including LEDs 101 in three colors (red LEDs, green LEDs and blue LEDs) arrayed thereon; a first reflector 103 which reflects the three colors of light emitted by the three LEDs 101 on the LED array substrate 102; a color mixing light guide plate 104, into which colored light beams emitted respectively by the red LEDs, blue LEDs and green LEDs enter through one edge thereof in the vicinity of the first reflector 103, and which causes color mixing of all of the colored light beams to obtain white light, and radiates the white light out from the other edge thereof; a second reflector 105 which reflects the white light radiated out from the other edge of the color mixing light guide plate 104 to allow the white light to enter one edge of the light guide plate 106.

In the back-lighting unit 100, the respective color beams from the red LEDs, blue LEDs and green LEDs mounted on the LED array substrate 102 are reflected by the first reflector 103, and are radiated toward one edge of the color mixing light guide plate 104 arranged next to both of the LED array substrate 102 and the first reflector 103. In the color mixing light guide plate 104, color mixing of all of the colored light beams is caused, and thereby the white light is obtained. The white light is guided out through the other edge of the color mixing light guide plate 104, is reflected by the second reflector 105, and is allowed to enter the light guide plate 106. The white light that is incident on the light guide plate 106 is emitted from a front surface thereof while traveling the light guide plate 106.

In the back-lighting unit 100 described as above, the color mixing light guide plate 104 is arranged at the back surface of the light guide plate 106, and the white light is obtained by mixing colors of emitting light from the three color LEDs. Thereby, high-brightness white light becomes available while keeping a narrow bezel area of the back-lighting unit. Additionally, in a liquid crystal display using this back-lighting unit, it becomes possible to realize a high-brightness full-color multilevel halftone color liquid crystal display having a wide color reproduction gamut by using high-brightness and high-power LEDs.

In the back-lighting unit described as above, however, there is the possibility that following problems occur.

A first problem is that there is a limit in heightening brightness of emitting light from the light guide plate 106. Furthermore, a difference in brightness in emitting light between two opposite edges of the light guide plate 106 tends to be large, that is, brightness non-uniformity tends to occur. Furthermore, a brightness difference in emitting light between each edge and a central part of the light guide plate 106 tends to be large.

The reason for the above is that the emitting light is emitted from the entire surface of the light guide plate 106 by allowing white light to enter one edge, which is relatively close to the second reflection plate 105, of the light guiding plate 106 and allowing the light to travel the light guiding plate 106 toward the other edge thereof. The longer a distance the white light travels, the more the light is scattered and dimmed, and hence the larger a difference there is in brightness of emitting light emitted from the light guide plate.

A second problem is that the back-lighting unit is structurally out of proper proportion.

The reason for the above is that components of the back-lighting unit are centered in one area close to the second reflector 105.

### SUMMARY OF THE INVENTION

Accordingly, an exemplary feature of the invention is to provide a back-lighting unit excellent in color reproduction of emitting light therefrom, adequate for heightening brightness of the emitting light, and capable of suppressing brightness non-uniformity of the emitting light.

A back-lighting unit of the invention comprising: a first light guide plate which radiates out, from one main front surface thereof, light having entered the first light guide plate; an LED array substrate arranged at a back surface of the first light guide plate and including light emitting diodes in plural colors arrayed thereon; a first optical member which reflects light emitted by the light emitting diodes on the LED array substrate; a plurality of second light guide plates into each of which color light beams emitted by the light emitting diodes on the LED array substrate enter through one edge thereof in the vicinity of the first optical member, and each of which causes color mixing of the color light beams, and radiates resultant light out from the other edge thereof; and a plurality of second optical members which, by reflecting light radiated out from the other edges of the respective light guide plates, allow the light to enter two opposite edges of the first light guide plate.

Preferably, the first and second light guide plates, and the first and second optical members are arranged in order that an entirety of them can be substantially line-symmetric with respect to a central part of the entirety.

Preferably, the first and second optical members are reflection plates.

Preferably, diffusion reflection patterns are provided on the back surface of the first light guide plate, the diffuse reflective patterns being patterns changing from each edge to a central part thereof.

Preferably, the light emitting diodes in plural colors are arrayed in plural lines on the LED array substrate, the first optical member is provided as a plurality of first optical members, and color light beams respectively emitted by the plural lines of light emitting diodes on the LED array substrate are reflected by the plurality of first optical members to be allowed to enter the plurality of light guide plates for color mixing.

Another back-lighting unit of the invention comprising: a first light guide plate which radiates out, from one main front surface thereof, light having entered the first light guide plate; an LED array substrate arranged at a back surface of the first light guide plate and including light emitting diodes in plural colors arrayed thereon; second light guide plates into which color light beams respectively emitted by the light emitting diodes enter through a recess, and which causes color mixing of the color light beams, and radiates resultant light out from two opposite edges thereof, the light guide plate including the recess provided thereon in a manner that the recess corresponds to an arrangement of the light emitting diodes mounted on the LED array substrate; and a plurality of optical members each of which, by reflecting light radiated out respectively from two opposite edges of the light guide plate, allow the light to enter two opposite edges of the first light guide plate.

Preferably, the first and second light guide plates, and the first and second optical members are arranged in order that they can be substantially line-symmetric with respect to a central part of the back-lighting unit.

Preferably, the plurality of optical members are reflection plates.

Preferably, diffuse reflective patterns are provided on the back surface of the first light guide plate, the diffuse reflective patterns being patterns changing from each edge of the first light guide plate to a central part thereof.

Preferably, a plurality of recesses are provided on a central part of the second light guide plate, and the plurality of light emitting diodes in plural colors mounted on the LED array substrate are arranged in a manner such that they are individually inserted into the plurality of recesses.

Preferably, a reflection surface, which reflects light emitted by the light emitting diodes to allow the light to enter the second light guide plate, is formed on each of the recesses of the second light guide plate.

Preferably, a single recess is provided on a central part of the second light guide plate, and the plurality of light emitting diodes in plural colors mounted on the LED array substrate are arranged in a manner that all of them are inserted into the single recess.

Preferably, a reflection surface, which reflects light emitted by the light emitting diodes to allow the light to enter the second light guide plate, is formed on the recess of the second light guide plate.

Preferably, the recess of the second light guide is a hole penetrating the second light guide plate, and an optical member, which reflects light emitted by the light emitting diodes to allow the light to enter the second light guide plate, is further arranged on the hole of the second light guide plate.

Furthermore, a liquid crystal display of the invention comprising: the back-lighting unit including the aspects as described above; a liquid crystal panel arranged above the back-lighting unit; an optical sheet which supplies, to the liquid crystal panel, back-light light emitted by the back-lighting unit by scattering or condensing the back-light light, the optical sheet being arranged between the back-lighting unit and the liquid crystal panel; and a frame member accommodating and fixing the back-lighting unit, the liquid crystal panel and the optical sheet.

Preferably, the first and second light guide plates, and the first and second optical members of the back-lighting unit are arranged in order that an entirety of these can be substantially line-symmetric with respect to a central part of the entirety.

Preferably, the light emitting diodes in plural colors are arrayed in plural lines on the LED array substrate of the back-lighting unit, the first optical member is provided as a plurality of first optical members, and color light beams respectively emitted by the plural lines of light emitting diodes on the LED array substrate are reflected by the plurality of first optical members to be allowed to enter the plurality of light guide plates for light color mixing.

Preferably, the first and second light guide plates, and the optical members of the back-lighting unit are arranged to be substantially line-symmetric with respect to a central part of the liquid crystal display.

Preferably, a plurality of recesses are provided on a central part of the second light guide plate of the back-lighting unit, and the plurality of light emitting diodes in plural colors mounted on the LED array substrate are arranged in a manner such that they are individually inserted into the plurality of recesses.

Preferably, a single recess is provided on a central part of the second light guide plate of the back-lighting unit, and the plurality of light emitting diodes in plural colors mounted on the LED array substrate are arranged in a manner such that the plurality of light emitting diodes are inserted into the single recess.

According to the back-lighting unit of the invention, emitting light of the light emitting diodes are allowed to enter directly the second light guide plate for color mixing, or enter one edge thereof after going through reflection at the first optical member or the like, the second light guide plate being arranged all around the light emitting diodes. In the second light guide plate, color mixing of the respective color light beams occurs with increasing distance from this one edge. In a case with color mixing of red, blue and green, white light is obtained. This white light is guided out through the other edge of the second guide light plate, is reflected by the second optical member or the like, and then is allowed to enter any one of the two opposite edges of the first light guide plate. While traveling through the first light guide plate, the white light having entered the first light guide plate is radiated out from one main front surface thereof, which is, for example, a front surface thereof.

Consequently, according to the back-lighting unit of the invention, as a first effect, a high-brightness back-light with a relatively narrow bezel area can be obtained, the back-light being excellent in surface uniformity of luminance. For example, a back-lighting unit can be obtained in which a brightness difference is small between edge parts and a central part of the first light guide plate, the back-light being excellent in surface uniformity of luminance. In other words, the back-lighting unit can be obtained in which a brightness difference is small between an edge part of the first light guide plate and the other edge part opposite thereto, the back-light being excellent in surface uniformity of luminance.

One reason for the above is that plural colors are mixed in the second light guide plates arranged at the back surface of the first light guide plate, and light resulting from the color mixing is allowed to respectively enter two opposite edges of the first light guide plate. Another reason is that the LED array substrate is arranged at a position corresponding to a central part of the first light guide plate, and color mixing is caused by allowing light emitted by light emitting diodes arrayed on the LED array substrate to enter the second light guide plates at both sides of the LED array substrate. That is, it is possible to cause color mixing of the emitting light from the LEDs on the LED array substrate in a well-balanced manner to obtain white light and to allow the white light to enter the first light guide plate.

Furthermore, as a second effect, module strength can be enhanced.

The reason for the above is that balance of the entire unit is enhanced since the entire unit substantially has a structure which is line-symmetric with respect to a central part thereof.

Furthermore, according to the liquid crystal display of the invention, it is possible to realize a liquid crystal display with a relatively narrow bezel area. Furthermore, total module strength of a liquid crystal display is enhanced. By using high-brightness and high-power LEDs, it becomes possible to realize a high-brightness full-color multilevel halftone liquid crystal display with a wide color reproduction gamut.

### BRIEF DESCRIPTION OF THE DRAWINGS

These and other objects and advantages, and further description of the invention will become more apparent to those skilled in the art by reference to the description, taken in connection with the accompanying drawings, in which:

FIG. 1A is a cross-sectional view of a back-lighting unit according to a first exemplary embodiment of the invention, taken along a longitudinal direction of the unit.

FIG. 1B is a cross-sectional view of an LED array substrate applied to the back-lighting unit in FIG. 1A.

FIG. 2 is a back side view of a first light guide plate 6 of the back-lighting unit in FIG. 1A.

FIG. 3 is a cross-sectional view of a liquid crystal display, to which the back-lighting unit in FIG. 1A is applied, according to the first exemplary embodiment of the invention, taken along a longitudinal direction of the display.

FIG. 4A is a cross-sectional view of a back-lighting unit according to a second exemplary embodiment of the invention, taken along a longitudinal direction of the unit.

FIG. 4B is a cross-sectional view of an LED array substrate applied to the back-lighting unit of FIG. 4A.

FIG. 5A is a cross-sectional view of a back-lighting unit according to an embodiment example 1 of the second exemplary embodiment, taken along a lateral direction of the unit.

FIG. 5B is a perspective cross-sectional view of a second light guide plate according to an embodiment example 1 of the second exemplary embodiment, with a back surface thereof being upturned.

FIG. 6A is a cross-sectional view of a back-lighting unit according to an embodiment example 2 of the second exemplary embodiment, taken along a lateral direction of the unit.

FIG. 6B is a perspective cross-sectional view of a second light guide plate according to an embodiment example 2 of the second exemplary embodiment, with a back surface thereof being upturned.

FIG. 7A is a cross-sectional view of a back-lighting unit according to a third exemplary embodiment of the invention, taken along a longitudinal direction of the unit.

FIG. 7B is a cross-sectional view of an LED array substrate applied to the back-lighting unit in FIG. 7A.

FIG. 7C is a cross-sectional view of the LED array substrate applied to the back-lighting unit in FIG. 7A, taken along a direction different from a direction along which FIG. 7B is taken.

FIG. 8A is a cross-sectional view of a liquid crystal display, to which the back-lighting unit of FIG. 4A is applied, according to the second exemplary embodiment of the invention, taken along a longitudinal direction of the display.

FIG. 8B is a cross-sectional view of a liquid crystal display, to which the back-lighting unit in FIG. 7A is applied, according to the third exemplary embodiment of the invention, taken along a longitudinal direction of the display.

FIG. 9A is a cross-sectional view of a back-lighting unit according to a prior art taken along a longitudinal direction of the unit.

FIG. 9B is a cross-sectional view of an LED array substrate applied to the back-lighting unit in FIG. 9A.

### DETAILED DESCRIPTION OF THE PREFERRED EMBODIMENTS

Hereinafter, exemplary embodiments of the invention will be described in detail with reference to the drawings.

First, a back-lighting unit according to a first exemplary embodiment of the invention will be described in detail with reference to the drawings.

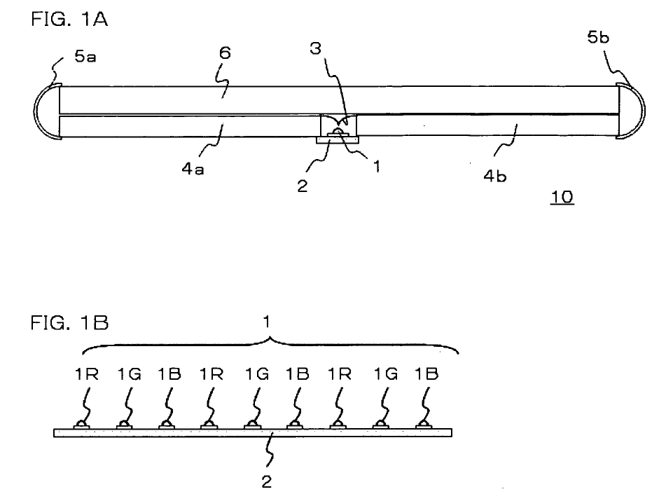

A back-lighting unit 10 of this embodiment, as shown in FIGS. 1A and 1B, includes: a first light guide plate 6 which radiates out, from one main front surface thereof, light having entered the first light guide plate 6; an LED array substrate 2 arranged at a back surface of the first light guide plate 6 and including three color LEDs 1 (red LEDs, green LEDs and blue LEDs) arrayed thereon; a first optical member 3 which reflects light emitted by the LEDs 1 on the LED array substrate 2; a plurality of second light guide plates 4a and 4b for light color mixing, into each of which color light beams respectively emitted by the red LEDs, green LEDs, and blue LEDs on the LED array substrate 2 enter through one edge thereof in the vicinity of the first optical member 3, and each of which causes color mixing to obtain white light, and radiates the white light out from the other edge thereof; a plurality of second optical members 5a, 5b which reflect white light radiated out from the other edges of the respective second light guide plates 4a and 4b and allow the white light to enter one edge of the first light guide plate 6. This back-lighting unit 10 is configured in a form substantially line-asymmetric with respect to a central part thereof.

Furthermore, in this embodiment, a first reflection plate 3 is used as the first optical member. Furthermore, in this embodiment, a plurality of second reflection plates 5a and 5b are used as the second optical members.

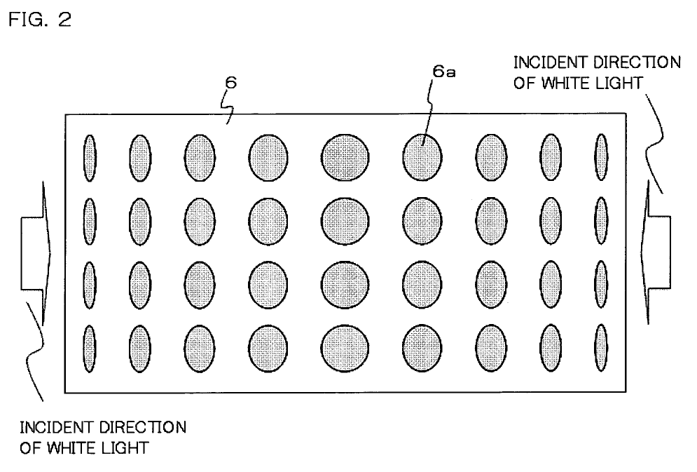

On the back surface of the first light guide plate 6, as shown in FIG. 2, diffuse reflective patterns 6a are formed with patterns changing from two opposite edges toward a central part. In this case, circular or elliptical shapes are used as the patterns. These diffuse reflective patterns 6a are, for example, a white film printed on the back surface of the first light guide plate 6. By use of these diffuse reflective patterns 6a increase in area towards center and allow greater reflectivity further from edge, when the white light is allowed to enter the first light guide plate 6 through the two opposite edges thereof as indicated by arrows in FIG. 2, smaller reflections are generated at the two opposite edges and large reflections are generated at the central part. The arrangement provides uniform lighting from the light guide plate 6.

Light color beams respectively from the red LEDs, blue LEDs and green LEDs, formed on the LED array substrate 2 are allowed to directly enter one edge of the second light guide plate 4a or 4b for color mixing, which is arranged to either side of the LEDs, or allowed to enter one edge of the second light guide plate 4a or 4b after going through reflection by the first reflection plate 3 as an example of the first optical member. In each of the second light guide plates 4a and 4b, color mixing of the respective color light beams occurs with increasing distance from this one edge, and thereby white light is obtained. This white light is guided out through the other edge of the second guide light plate 4a or 4b, is reflected by the second reflection plate 5a or 5b, and then is allowed to enter either of two opposite edges of the first light guide plate 6. While traveling through the light guide plate 6 by use of the diffuse reflective patterns 6a, the white light having entered the first light guide plate 6 is radiated out evenly from a front surface thereof which is the one main front surface thereof.

With this back-lighting unit 10, as a result of the following course of events, it is possible to obtain, a high-brightness back-light excellent in surface uniformity of luminance while keeping a narrow bezel area of the unit. White light is obtained by allowing a red light beam, a green light beam, and a blue light beam from the plurality of LEDs 1 (1R, 1G and 1B) to enter the second light guide plate 4a or 4b and to undergo the color mixing, and the obtained white light is allowed to enter either of the two opposite edges of the first light guide plate 6. It is also possible to obtain white light resulting from color mixing where the red, green and blue light beams from the LEDs 1 arrayed on the LED array substrate 2 are mixed in a well-balanced manner.

Additionally, an entirety of the back-lighting unit 10 substantially has a structure line-symmetric with respect to a central part thereof, whereby weight proportion is enhanced and stress concentration become unlikely to occur. Therefore, total module strength of the unit can be enhanced.

Furthermore, by allowing white light to enter the first light guide plate 6 through the two opposite edges thereof, it suffices to design, as the diffuse reflective patterns 6a, patterns changing from each edge of the first light guide plate 6 toward a central part thereof, and the patterns can be made line-symmetric with respect to the central part. Therefore, designing and manufacturing of the light guide plate 6 and the diffuse reflective patterns 6a can be less costly.

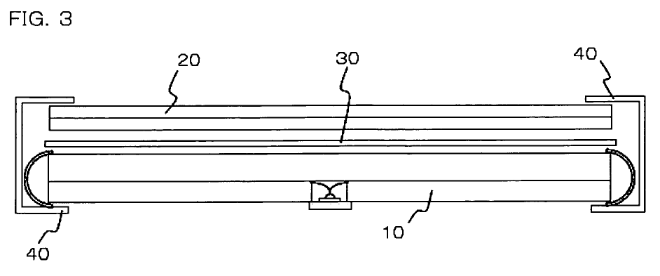

Next, a liquid crystal display, to which the back-lighting unit of the first exemplary embodiment is applied, according to the first exemplary embodiment of the invention will be described by referring to FIG. 3 of the drawings.

This liquid crystal display includes: a back-lighting unit 10; a liquid crystal panel 20 of a transmission or semi-transmission type arranged above the back-lighting unit 10; an optical sheet 30 which supplies, to the liquid crystal panel 20, back-light light emitted by the back-lighting unit 10 by scattering or condensing the back-light light, the optical sheet 30 being arranged between the back-lighting unit 10 and the liquid crystal panel 20; a frame member 40 accommodating and fixing these components. As shown in FIGS. 1A and 1B, the back-lighting unit 10 further includes: a first light guide plate 6 which radiates out, from one main front surface thereof, light having entered the first light guide plate 6; an LED array substrate 2 arranged at a back surface of the first light guide plate 6 and including three color LEDs 1 (red LEDs, green LEDs and blue LEDs) arrayed thereon; a first reflection plate 3 as an example of a first optical member which reflects light emitted by the LEDs 1 on the LED array substrate 2; a plurality of second light guide plates 4a and 4b for light color mixing, into each of which color light beams respectively emitted by the red LEDs, green LEDs, and blue LEDs on the LED array substrate 2 enter through one edge thereof in the vicinity of the first reflection plate 3, and each of which causes color mixing of the color light beams to obtain white light, and radiates the white light out from the other edge thereof; a plurality of second reflection plates 5a and 5b as an example of a plurality of second optical members which reflect white light radiated out from the other edges of the respective second light guide plates 4a and 4b for color mixing, and allow the white light to enter one edge of the first light guide plate 6. The back-lighting unit 10 radiates a back-light light for the liquid crystal panel 20 of a transmission or semi-transmission type.

With a structure as described above, it becomes possible to realize a liquid crystal display with a relatively narrow bezel area. It is also possible to obtain a high-brightness liquid crystal display excellent in surface uniformity of luminance. That is, a brightness difference becomes small between edge parts and a central part of the display, and surface uniformity of luminance is enhanced. Additionally, a brightness difference is small between an edge of the display and the other edge opposed thereto, and surface uniformity of luminance is enhanced. Furthermore, total module strength of a liquid crystal display is enhanced. Furthermore, by using high-brightness and high-power LEDs, it becomes possible to realize a high-brightness full-color multilevel halftone liquid crystal display with a wide color reproduction gamut.

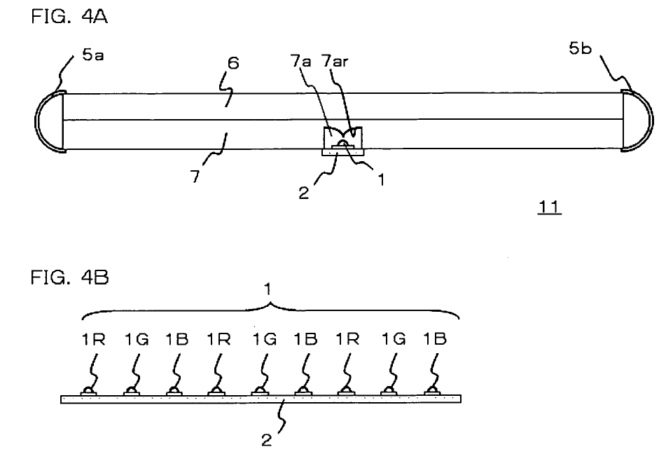

Next, a back-lighting unit according to a second exemplary embodiment of the invention will be described in detail with reference to FIGS. 4A and 4B of the drawings.

In a back-lighting unit 11 of this embodiment, with respect to LEDs 1, an LED array substrate 2, second reflection plates 5a and 5b as an example of second optical members, and a first light guide plate 6, the same components as described above of the first embodiment are used. Detailed descriptions thereof will be omitted as the same components are used.

A back-lighting unit 11 of this embodiment, as shown in FIGS. 4A and 4B, includes: a first light guide plate 6 which radiates out, from one main front surface thereof, light having entered the first light guide plate 6; an LED array substrate 2 arranged on a back surface of the first light guide plate 6 and including three color LEDs 1 (1R, 1G, and 1B) arrayed thereon; a second light guide plate 7 for light color mixing, into which color light beams respectively emitted by the LEDs 1 enter through a recess 7a, and which causes color mixing of the light beams, and radiates resultant light from two opposite edges thereof, the second light guide plate 7 accommodating the LEDs 1 by including the recess 7a provided in a manner that it corresponds to an arrangement of the LEDs 1 mounted on the LED array substrate 2; a plurality of second reflection plates 5a and 5b as an example of a plurality of second optical members which reflect light radiated out respectively from two opposite edges of the second light guide plate 7 to allow the light to enter two opposite edges of the first light guide plate 6. For diffuse reflective patterns on the back surface of the first light guide plate 6, the patterns shown in FIG. 2 may be used.

Specifically, the back-lighting unit 11 of this embodiment is characterized in that the single second light guide plate 7 is used as a light guide plate for causing color mixing of light emitted by the LEDs 1. In a manner allowing the recess 7a to correspond to the arrangement of the LEDs 1 mounted on the LED array substrate 2, the recess 7a is formed in a central part of the second light guide plate 7. On the recess 7a, a reflection surface 7ar is formed for the purpose of facilitating entrance of light emitted by the LEDs 1 into the second light guide plate 7. In the recess 7a, the LEDs 1 are accommodated.

Light emitted by the LEDs 1 (1R, 1G and 1B) arrayed on the LED array substrate 2, directly, or after going through reflection at the reflection surface 7ar of the recess 7a, enters the second light guide plate 7. Thus, the color mixing is caused, whereby white light is obtained.

With this back-lighting unit of this embodiment, as compared with the abovementioned back-lighting unit of the first exemplary embodiment, the number of peripheral components around a light guide plate for color mixing can be reduced, whereby assembling thereof can be simplified. Manufacturing variation attributable to assembling can be reduced.

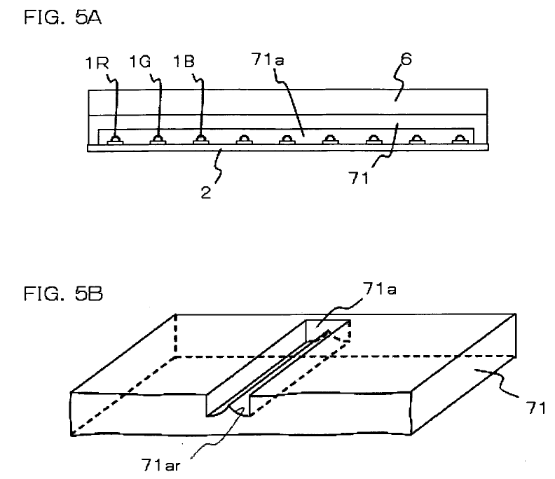

Next, as a concrete example of the abovementioned second exemplary embodiment, an embodiment example 1 will be described. In this embodiment example, as the recess in the second light guide plate for color mixing, as shown in FIGS. 5A and 5B, a single recess 71a of an elongated shape accommodating the plurality of LEDs 1R, 1G and 1B on the LED array substrate is formed in a second light guide plate 71. The respective LEDs 1 are accommodated in the single recess 71a. Light emitted by the plurality of LEDs 1R, 1G and 1B enters the second light guide plate 71 through side surfaces of the single recess 71a, or through side surfaces of the single recess 71a after going through reflection at a reflection surface 71ar of the recess 71a, and color mixing is caused. Furthermore, white light generated by the color mixing travels the second light guide plate 71 to reach the second reflection plates 5a and 5b shown in FIG. 4A. In this embodiment example, by providing a recess of a simple shape on a light guide plate, the color mixing of light from a plurality of LEDs can be realized.

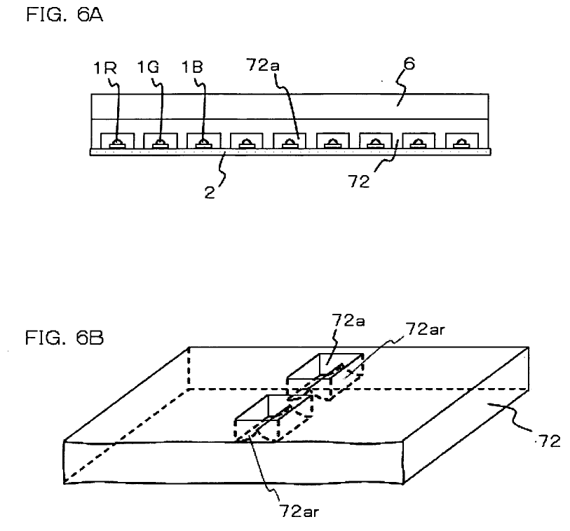

Next, as another concrete example of the abovementioned second exemplary embodiment, an embodiment example 2 will be described. In this embodiment example, as the recess in the second light guide plate for color mixing, as shown in FIGS. 6A and 6B, a recess 72a accommodating one of the plurality of LEDs 1R, 1G and 1B on the LED array substrate is provided in plurality and is formed in a second light guide plate 72. A plurality of the LEDs 1 are accommodated in one of the recesses 72a, respectively. Light emitted by the plurality of LEDs 1R, 1G and 1B enter the second light guide plate 72 through side surfaces of the respective recesses 72a, or through side surfaces of the respective recesses 72a after going through reflection at reflection surfaces 72ar of the respective recesses 72a, and color mixing is caused. Furthermore, white light generated in the color mixing travels the second light guide plate 72 to reach the second reflection plates 5a and 5b shown in FIG. 4A. In this embodiment example, by providing on the light guide plate the plurality of recesses each accommodating one of the LEDs, light emitted by the respective LEDs enter the recesses 72a surrounding the respective LEDs with relatively small loss of light. Thus, as compared with the embodiment example 1, it is possible to efficiently realize color mixing of light emitted by a plurality of LEDs to obtain white light.

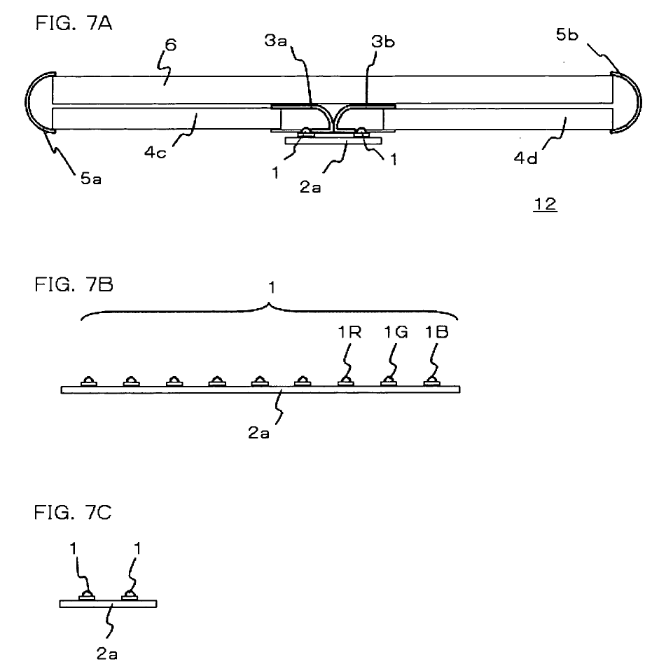

Next, a back-lighting unit according to a third exemplary embodiment of the invention will be described with reference to FIGS. 7A to 7C.

This third exemplary embodiment is a modified example of the first exemplary embodiment shown in FIG. 1A, and uses a plurality of color mixing light guide plates as in the case with the first exemplary embodiment.

In a back-lighting unit 12 of this embodiment, with respect to LEDs 1, an LED array substrate 2, second reflection plates 5a and 5b as an example of second optical members, and a first light guide plate 6, the ones similar to what are used in the abovementioned back-lighting units 10 and 11 of the first and second exemplary embodiments are used. Detailed descriptions thereof will be omitted as the similar ones are used.

A back-lighting unit 12 of this embodiment includes: the first light guide plate 6 which radiates out, from one main front surface thereof, light having entered the first light guide plate 6; the LED array substrate 2a arranged at a back surface of the first light guide plate 6 and including LEDs 1 (1R, 1G, and 1B) in three colors arrayed thereon, the LED array substrate 2a including the three color LEDs 1 in plural lines arrayed thereon; a plurality of first reflection plates 3a and 3b as an example of a plurality of first optical members which reflect light emitted by the LEDs 1 in the respective lines thereof on the LED array substrate 2a; a second light guide plate 4c for light color mixing, into which color light beams respectively emitted by the LEDs 1 on the LED array substrate 2a enter through one edge thereof in the vicinity of the first reflection plate 3a, and which causes color mixing of the light beams, and radiates resultant light out from the other edge thereof; a second light guide plate 4d for light color mixing, into which color light beams respectively emitted by the LEDs 1 on the LED array substrate 2a enter through one edge thereof in the vicinity of the first reflection plate 3b, and which causes color mixing of the light beams, and radiates resultant light out from the other edge thereof; a plurality of second reflection plates 5a and 5b as an example of a plurality of second optical members which reflect light radiated out from the respective other edges of the second light guide plates 4c and 4d to allow the light to enter both respective edges of the first light guide plate 6. For diffuse reflective patterns on the back surface of the first light guide plate 6, the patterns shown in FIG. 2 may be used.

Specifically, in this embodiment, the three color LEDs 1 are arrayed in plural lines on the LED array substrate 2a, the plurality of first reflection plates 3a and 3b are provided as the plurality of first optical members. Thereby, color light beams respectively emitted by the LEDs 1 in the plural lines on the LED array substrate 2a are reflected by the first reflection plates 3a and 3b, and enter respectively the second light guide plates 4c and 4d for light color mixing.

In this embodiment, in addition to the effects according to the abovementioned exemplary embodiments, the following effects are obtained by using the LED array substrate 2a on which the LEDs 1 are arrayed in the plural lines. Accordingly, it becomes possible to heighten brightness with an increased number of light sources, and a structure and installation thereof can be simplified because it is only necessary to prepare a single substrate as a LED array substrate and hence to treat only the single substrate with a countermeasure for heat dissipation.

Hereinabove, the preferred exemplary embodiments have been described. However, with respect to the diffuse reflective patterns on the back surface of the light guide plate 6, that is not limited to the ones having circular and elliptical shapes as shown in FIG. 2, and a gradation pattern having other shapes such as quadrangular, linear or dot-like shapes may be used. Additionally, instead of using a printed white film, the patterns can be also realized by using a metal film deposited thereon or by forming the back surface of the light guide plate as a concavo-convex surface where pitches are gradually changed.

Furthermore, although the cases where the reflection plates are used as the first and second optical members have been described as examples, instead of using a reflection plate, a different member performing the same functions, such as a prism, an optical fiber or a light guide body, may be used.

Furthermore, although the recess is provided on the second light guide plates 7, 71 and 72 in any one of the abovementioned second exemplary embodiment, and the abovementioned embodiment examples 1 and 2 of the second exemplary embodiment, a hole penetrating the second light guide plate may be alternatively provided for the purpose of facilitating a process applied to the second light guide plate. In each of these cases, a reflection plate of a separate member as shown in the first exemplary embodiment is inserted and arranged in each hole of the second light guide plate. Specifically, for a type in which one light emitting diode is arranged individually in one recess as is the case with the embodiment example 2 of the abovementioned second exemplary embodiment, each of the recesses is replaced by a hole penetrating the light guide plate, and reflection plates are inserted and arranged in the respective holes. For a type in which a plurality of light emitting diodes are arranged in a single recess as is the case with the embodiment example 1 of the abovementioned second exemplary embodiment, the recess is replaced by a hole penetrating the light guide plate, and one reflection plate is inserted and arranged in the hole.

Furthermore, a liquid crystal display using any one of the back-lighting units 11 and 12 respectively of the second and third exemplary embodiments will be described hereinbelow. The structures of the back-lighting units 11 and 12 have been described hereinabove, and hence descriptions thereof will be omitted here.

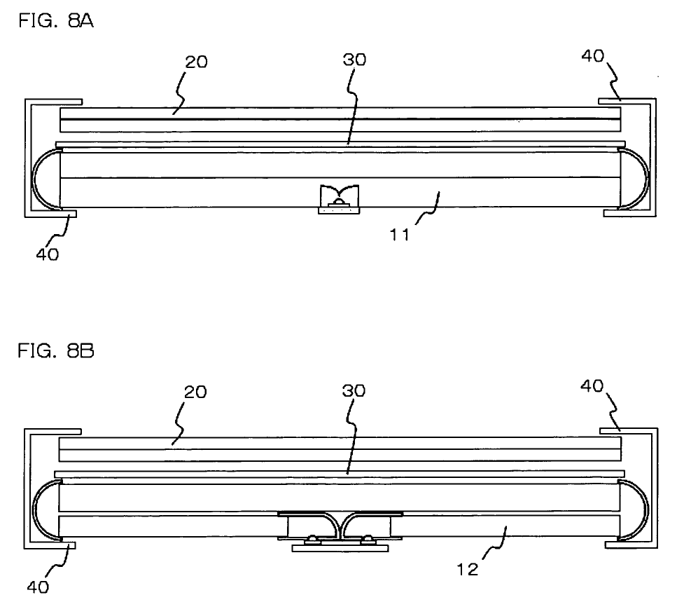

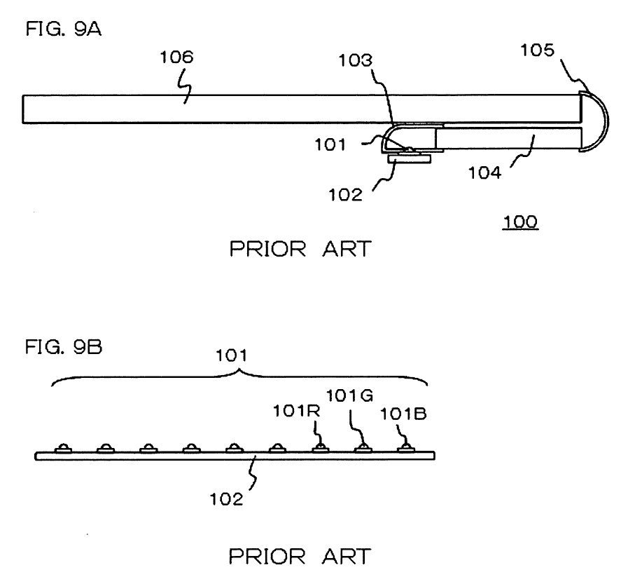

As shown in FIG. 8A, a liquid crystal display according to the second exemplary embodiment, to which the back-lighting unit 11 according to the second exemplary embodiment is applied, includes: the back-lighting unit 11; a liquid crystal panel 20 of a transmission or semi-transmission type arranged above the back-lighting unit 11; an optical sheet 30 which supplies, to the liquid crystal panel 20, back-light light emitted by the back-lighting unit 11 by scattering or condensing the back-light light, the optical sheet 30 being arranged between the back-lighting unit 11 and the liquid crystal panel 20; a frame member 40 accommodating and fixing these components.

As shown in FIG. 8B, a liquid crystal display according to the third exemplary embodiment, to which the back-lighting unit 12 according to the third exemplary embodiment is applied, includes: the back-lighting unit 12; a liquid crystal panel 20 of a transmission or semi-transmission type arranged above the back-lighting unit 12; an optical sheet 30 which supplies, to the liquid crystal panel 20, back-light light emitted by the back-lighting unit 12 by scattering or condensing the back-light light, the optical sheet 30 being arranged between the back-lighting unit 12 and the liquid crystal panel 20; a frame member 40 accommodating and fixing these components.

With a structure as those described above, it is possible to realize a liquid crystal display with a relatively narrow bezel area. Additionally, it is possible to obtain a high-brightness liquid crystal display excellent in surface uniformity of luminance. That is, a brightness difference is small between edge parts and a central part of the display, and surface uniformity of luminance is enhanced. Additionally, a brightness difference is small between an edge of the display and the other edge opposed thereto, and surface uniformity of luminance is enhanced. Furthermore, total module strength of a liquid crystal display is enhanced. Furthermore, by using high-brightness and high-power LEDs, it becomes possible to realize a high-brightness full-color multilevel halftone liquid crystal display with a wide color reproduction gamut. Additionally, it can be considered to utilize the thus described liquid crystal display in photography and printing fields where sophisticated color reproduction is demanded.

Although the preferred embodiments of the invention have been described with reference to the drawings, it will be obvious to those skilled in the art that various changes or modifications may be made without departing from the true scope of the invention.

What is claimed is:

1. A back-lighting unit comprising:
a first light guide plate which radiates out, from one main front surface thereof, light having entered the first light guide plate;
an LED array substrate arranged at a back surface of the first light guide plate and including light emitting diodes in plural colors arrayed thereon;
a first optical member which reflects light emitted by the light emitting diodes on the LED array substrate;
a plurality of second light guide plates into each of which color light beams respectively emitted by the light emitting diodes on the LED array substrate enter through one edge thereof in the vicinity of the first optical member, and each of which causes color mixing of the color light beams, and radiates resultant light out from an opposite edge thereof; and
a plurality of second optical members which, by reflecting light radiated out from opposite edges of the respective second light guide plates, allow the light to enter two opposite edges of the first light guide plate.

2. The back-lighting unit according to claim 1, wherein the first light guide plate and the plurality of second light guide plates, and the first optical member and the plurality of second optical members are arranged to be substantially line-symmetric with respect to a central part of the entirety.

3. The back-lighting unit according to claim 2, wherein the first optical member and the plurality of second optical members are reflection plates.

4. The back-lighting unit according to claim 2, wherein diffuse reflective patterns are provided on a back surface of the first light guide plate, the diffuse reflective patterns being patterns changing from each edge part of the first light guide to a central part thereof.

5. The back-lighting unit according to claim 1, wherein the light emitting diodes in plural colors are arrayed in plural lines on the LED array substrate, the first optical member is provided as a plurality of first optical members, and color light beams respectively emitted by the plural lines of light emitting diodes on the LED array substrate are reflected by the plurality of first optical members so as to enter the plurality of second light guide plates for light color mixing.

6. A back-lighting unit comprising:
a first light guide plate which radiates out, from one main front surface thereof, light having entered the first light guide plate;
an LED array substrate arranged at a back surface of the first light guide plate and including light emitting diodes in plural colors arrayed thereon;
a second light guide plate into which color light beams respectively emitted by the light emitting diodes enter through a recess, and which causes color mixing of the color light beams, and radiates resultant light out from two opposite edges thereof, the second light guide plate including the recess provided therein in a manner that the recess corresponds to an arrangement of the light emitting diodes mounted on the LED array substrate; and
a plurality of optical members each of which, by reflecting light radiated out respectively from two opposite edges of the second light guide plate, allow the light to enter two opposite edges of the first light guide plate.

7. The back-lighting unit according to claim 6, wherein the first and second light guide plates, and the first and second optical members are arranged to be substantially line-symmetric with respect to a central part of the light source unit.

8. The back-lighting unit according to claim 7, wherein the plurality of optical members are reflection plates.

9. The back-lighting unit according to claim 7, wherein diffuse reflective patterns are provided on a back surface of the first light guide plate, the diffuse reflective patterns being varying patterns changing from each edge part of the first light guide plate to a central part thereof.

10. The back-lighting unit according to claim 6, wherein a plurality of recesses are provided on a central part of the second light guide plate, and the plurality of light emitting diodes in plural colors mounted on the LED array substrate are arranged in a manner such that they are individually inserted into the plurality of recesses.

11. The back-lighting unit according to claim 10, wherein a reflection surface, which reflects light emitted by the light emitting diodes to allow the light to enter the second light guide plate, is formed on each of the recesses of the second light guide plate.

12. The back-lighting unit according to claim 6, wherein a single recess is provided on a central part of the second light guide plate, and the plurality of light emitting diodes in plural colors mounted on the LED array substrate are arranged in a manner such that the plurality of light emitting diodes are inserted into the single recess.

13. The back-lighting unit according to claim 12, wherein a reflection surface, which reflects light emitted by the light emitting diodes to allow the light to enter the second light guide plate, is formed on the recess of the second light guide plate.

14. A liquid crystal display comprising:
a back-lighting unit;
a liquid crystal panel arranged above the back-lighting unit;
an optical sheet which supplies, to the liquid crystal panel, back-light light emitted by the back-lighting unit by performing any one of scattering and condensing of the back-light light, the optical sheet being arranged between the back-lighting unit and the liquid crystal panel; and
a frame part accommodating and fixing the back-lighting unit, the liquid crystal panel and the optical sheet,
the back-lighting unit including a first light guide plate which radiates out, from one main front surface thereof, light having entered the first light guide plate; an LED array substrate arranged at a back surface of the first light guide plate and including light emitting diodes in plural colors arrayed thereon; a first optical member which reflects light emitted by the light emitting diodes on the LED array substrate; a plurality of second light guide plates into each of which color light beams respectively emitted by the light emitting diodes on the LED array substrate enter through one edge thereof in the vicinity of the first optical member, and each of which causes color mixing of the color light beams, and radiates resultant light out from an opposite edge thereof; a plurality of second optical members which, by reflecting light radiated out from opposite edges of the respective second light guide plates, allow the light to enter two opposite edges of the first light guide plate.

15. The liquid crystal display according to claim 14, wherein the first and second light guide plates, and the first optical member and the plurality of second optical members of the back-lighting unit are arranged to be substantially line-symmetric with respect to a central part of the liquid crystal display.

16. The liquid crystal display according to claim 14, wherein the light emitting diodes in plural colors are arrayed in plural lines on the LED array substrate of the back-lighting unit, the first optical member is provided in plurality, and color light beams respectively emitted by the plural lines of light emitting diodes on the LED array substrate are reflected by the plurality of first optical members to be allowed to enter the plurality of light guide plates for light color mixing.

17. A liquid crystal display comprising:
a back-lighting unit;
a liquid crystal panel arranged above the back-lighting unit;
an optical sheet which supplies, to the liquid crystal panel, back-light light emitted by the back-lighting unit by performing any one of scattering and condensing of the back-light light, the optical sheet being arranged between the back-lighting unit and the liquid crystal panel; and
a frame part accommodating and fixing the back-lighting unit, the liquid crystal panel and the optical sheet,
the back-lighting unit including a first light guide plate which radiates out, from one main front surface thereof, light having entered the first light guide plate; an LED array substrate arranged at a back surface of the first light guide plate and including light emitting diodes in plural colors arrayed thereon; a second light guide plate into which color light beams respectively emitted by the light emitting diodes enter through a recess, and which causes color mixing of the color light beams, and radiates resultant light out from two opposite edges thereof, the light guide plate including the recess provided thereon in a manner that the recess corresponds to an arrangement of the light emitting diodes mounted on the LED array substrate; and a plurality of optical members each of which, by reflecting light radiated out respectively from two opposite edges of the second light guide plate, allow the light to enter two opposite edges of the first light guide plate.

18. The liquid crystal display according to claim 17, wherein the first and second light guide plates, and the optical members of the back-lighting unit are arranged to be substantially line-symmetric with respect to a central part of the liquid crystal display.

19. The liquid crystal display according to claim 17, wherein a plurality of recesses are provided on a central part of the second light guide plate of the back-lighting unit, and the plurality of light emitting diodes in plural colors mounted on the LED array substrate are arranged in a manner such that they are individually inserted into the plurality of recesses.

20. The liquid crystal display according to claim 17, wherein a single recess is provided on a central part of the second light guide plate of the back-lighting unit, and the plurality of light emitting diodes in plural colors mounted on the LED array substrate are arranged in a manner such that the plurality of light emitting diodes are inserted into the single recess.
